(19) United States
(12) Patent Application Publication
(10) Pub. No.: US 2021/0383485 A1
(43) Pub. Date: Dec. 9, 2021

(54) SYSTEMS, METHODS, AND APPARATUSES FOR FACILITAING POWERING OF TRANSOCEANIC SHIPPING AND INTERNATIONAL ENERGY/CHEMICAL SUPPLY

(71) Applicant: Benjamin Richard Markham, New York, NY (US)

(72) Inventor: Benjamin Richard Markham, New York, NY (US)

(21) Appl. No.: 17/339,982

(22) Filed: Jun. 5, 2021

Related U.S. Application Data
(60) Provisional application No. 63/035,484, filed on Jun. 5, 2020.

(51) Int. Cl. G06Q 50/06; G06Q 10/08

(52) U.S. Cl. CPC G06Q 50/06; G06Q 10/0831

(57) ABSTRACT

A system of Ocean-based barges following slow speed annual migration patterns that can net more incident solar energy, per unit area, than ever previously disclosed. This system makes use of solar radiant energy, seawater, and air to make most of the fuels/chemicals necessary for human life. These chemicals and/or fuels can then be efficiently distributed anywhere in the World by use of slow speed/low drag force travel, ocean currents, and/or transiting cargo ships. This system can power the entire Worlds global shipping industry, serve as an international decentralized energy grid, and/or provide a stored renewable energy reservoir of 100+ years.

### FIELD OF THE INVENTION

The necessity to transition away from fossil fuels as an energy source is the greatest threat to future human civilization on Earth. This is well understood and accepted in the scientific, political, and economic communities.

### BACKGROUND ART

Solar radiant energy is a promising path in present day but:
Is not cost competitive in many regions of the World due to low solar resource
Will require multitrillion-dollar infrastructure investments that must be optimized for cost, human convenience, and timeliness
Is an intermittent source that lacks a clear path forward to 100+ year energy reverses that rival those of Fossil Fuels or Nuclear Fission

Furthermore, our entire World economy is dependent on transoceanic shipping of goods, fuels, and commodity chemicals. Transitioning transoceanic shipping power from fossil fuels to Solar power presents a great challenge. This requires a replacement fuel that is either Carbon free or Carbon neutral. Industry is actively making steps to build cargo ships powered from alternative fuels (Ammonia, Liquid Natural Gas, Methanol, Hydrogen, etc.). These fuels will drive electric drive motors powered by fuel cells and/or internal combustion engines. The intended origin of these fuels is land based refueling in port.

Exclusively relying on shore-supplied fuels with no refueling at sea is the most convenient option for industry to take, but the convenient answer is not always the optimum one. Concerns with this method:

J.
Fuel tank size: With no at sea refueling option a combination of larger tanks, high pressure, and/or refrigeration will be required for Ammonia, Methanol, or Hydrogen powered ships.
Land Based Electrical grid stress: Any solar/wind power produced on land should be used to DIRECTLY offset fossil fuels in the local grid.
Lack of Raw materials in High Solar insolation environments: The world's highest land-based solar insolation environments exist in deserts. (Examples: Sahara Desert, Australia, Middle East, Southwestern United States, Andes Mountains). They are naturally devoid of the required ingredient (water) to produce chemical fuels. This then requires transportation of vast quantities of water or electricity hundreds of miles.

This invention aims to solve all of the above problems in the most energetically and economically optimized manner.

### PATENT LITERATURE

Maritime power plant system with processes for producing, storing, and consuming (U.S. Pat. No. 6,100,600A)
Large-scale ocean mobile solar power generation system (US Patent Application Publication US20120242275A1)
Hybrid Energy System for General Applications (US Patent Application Publication US20170012430A1)

Patent literature 1-3 includes many similar parts of this disclosure, mainly the general idea of harvesting solar power on the ocean and production of chemicals/fuels. They however they are not optimized in a time, energy, and economical ways that would solve the stated issues. They alone are not economically compelling solutions for transition to renewable energy on a global scale. Therefore, there is a need for improved systems, methods, and apparatuses for facilitating powering of transoceanic shipping and International energy/chemical supply that may overcome the above-mentioned problems and/or limitations.

### BRIEF SUMMARY OF THE INVENTION

Like patent literature 1-3 the invention uses solar radiant energy, seawater, and air as raw materials to create chemicals/fuels. This invention improves on prior art by adding global scale processes that solve the stated issues in BACKGROUND ART. The invention discloses 2 major types of ocean based floating barges, Storage and Supply barges. The barges perform the following processes:
Provide low cost renewable energy derived fuels/chemicals via an annual North/South migration pattern spanning 1000's of nautical miles to maximize solar collection in all seasons and efficient global distribution simultaneously
Provide Carbon neutral at sea refueling to the global shipping industry with a network of fuel/chemical storage barges throughout the Worlds major shipping lanes
Provide an international decentralized energy grid that efficiently distributes renewable fuels/chemicals to any costal region and has the potential to scale up to 100+ year energy reserves

### BRIEF DESCRIPTION OF THE DRAWINGS

FIG. 1 shows the annual migration pattern concept. It also shows average solar irradiance values on the highest land-based locations in the World. The ocean based “goal” corresponds to a conversative calculation of ocean based solar irradiance at in the Atlantic ocean. following the migration path used in FIG. 2. This was calculated with historic monthly and weekly NASA solar insolation data.

FIG. 2 is contour plot the hours of daylight as a function of latitude and day of the year. The dotted line represents a typical supply barge annual path in the Pacific or Atlantic Ocean. The slope of the line corresponds to ˜1 nautical mile per hour.

FIG. 3 is an illustration of supply barges along major shipping lanes. These can serve as a reservoir for refueling cargo ships transiting the open ocean. Additionally, the fuels/commodity chemicals can be extracted from these barges and transported to land.

FIG. 4 is an illustration of supply barges along the World's major ocean currents. This allows for efficient transportation of fuels/chemicals to the vicinity of continents with little or no propulsion energy input.

### DETAILED DESCRIPTION OF THE INVENTION

### Supply Barge Migration Optimization Process

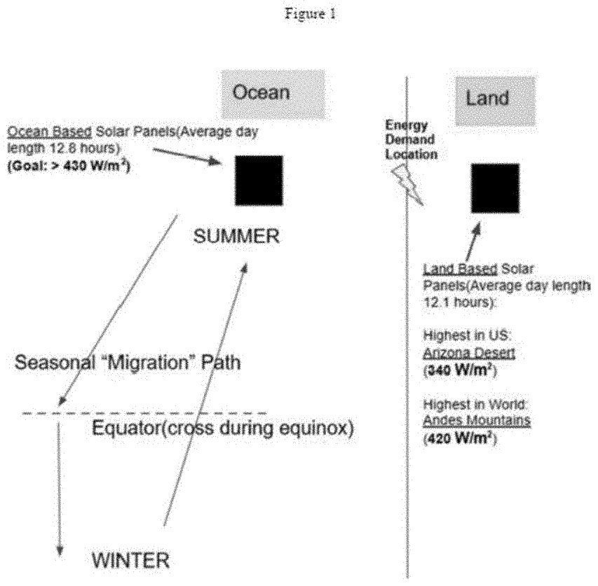

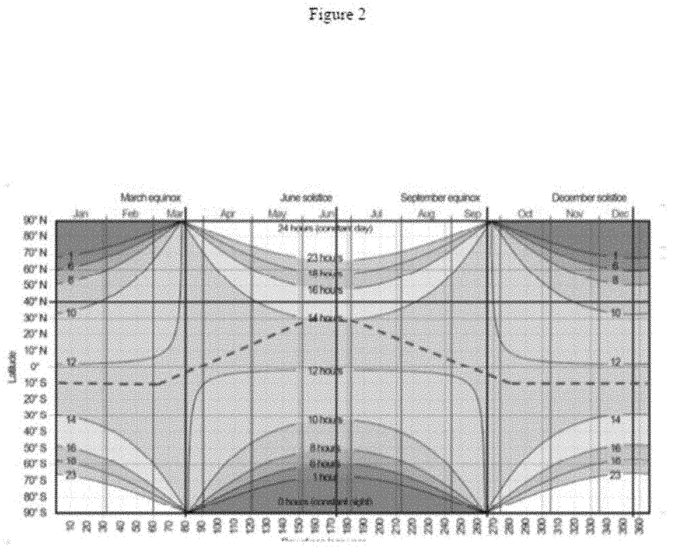

The purpose of supply barges to produce useful chemicals/fuels and distribute them to the storage barges. The raw materials are seawater and air, the energy source for these chemical reactions is solar radiant energy. This can be in the form of a photovoltaic cell, solar thermal, and/or use of optical lens/resonator. Supply barges make use of propulsion motors, currents, and/or wind to follow an annual migration pattern. (In some complicated cases/regions a 6 month, 2 year, or other cycle may be optimum. For example, due to cloud cover, Indian ocean, and at extreme latitudes >45S or >45N) As can be seen in FIGS. 1 and 2, the purpose of this migration pattern is to take advantage of ≥12 hour days in all seasons and essentially skip Winter, not unlike some species of birds. At the conclusion of this annual pattern, they deposit their harvested chemicals/fuel into a storage barge and then repeat the process.

For any given supply barge longitude and it's associated storage barge latitude, an initial migration path similar to FIG. 2 is determined as follows. Determine the North/South migration anchor points using historical cloud/solar irradiance data as guidance. Typically, the assigned storage barge will be North anchor point. Once the North and South migration extremes are chosen for a specific longitude, the Fall/Spring migration pattern is determined. It is generally optimal to start migrating about 2 weeks before the equinox, pass the equator on equinox, and continue migrating another 2 weeks. This is due to the rapidly changing daylengths around the equinoxes. You can see this in FIG. 2, also note the opposite effect near the solstice. This staring point migration pattern can be improved with more data.

The highest land based solar irradiance location in the World is the Andes Mountains with 420 W/m2, The SW US, Sahara Desert, Middle East, South Africa, and Australia are all roughly tied for 2nd with 340 W/m2. Using weekly/monthly NASA historic solar irradiance data and following the disclosed migration pattern process shown in FIG. 2 between (10-25) West in the Atlantic Ocean. Conservative calculations showed an annual average of >430 W/m2 is achievable. A similar migration pattern in the Western pacific at (135-150) West has an annual average around 380 W/m2.

A supply barge following a pattern similar to the one shown in FIG. 2 will on annual average day length of approximately a 12.8 hours/day. This gives approximately a 6% daylight advantage relative to a stationary latitude solar installation with identical design/weather conditions.

Of course, this is an idealization, some of this energy surplus is spent on the energy required for the migration. Though this is easily mitigated. Because drag forced is proportional to the square of the barge transit speed, the energy required is therefore proportional to the cube of transit speed. Approximately 1 nautical mile per hour was chosen via calculation to be a suitable default migration speed. This allows for North/South travel of about 12 degrees per month but still maintains propulsion loses low enough for the migration to be energetically profitable. This calculation was completed conservatively, improved hydrodynamic design, propeller efficiency, strategic use of ocean currents, and use of a retractable sail when the sun goes down could all aid to lower propulsion losses by a factor of 10 or more.

The supply barges following the disclosed migration patterns in will have comparable if not more net solar radiant energy incident than the highest previously disclosed solar installations in the World. This fact combined with, readily available seawater resource, and slow speed low energy input distribution make this disclosure useful and likely competitive in a future market.

### Storage Barges

Storage Barges are essentially large floating tanks that store large reservoirs of fuels/chemicals provided by supply barges. They will have minimal propulsion capability due to their large cross-sectional area and will mainly make strategic use of ocean currents to maintain in shipping lanes and/or major ocean currents.

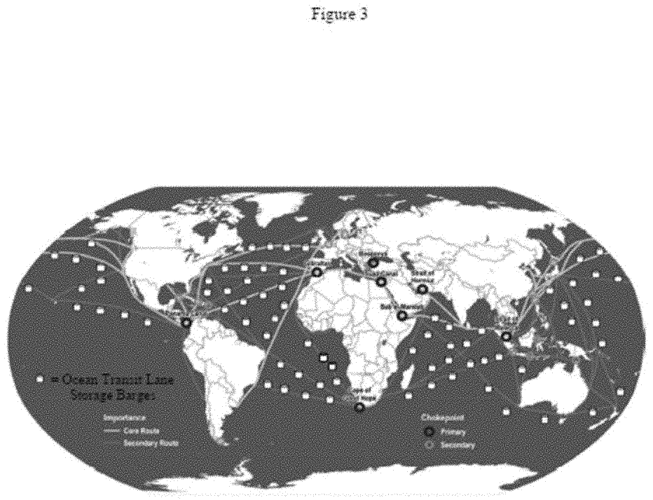

Storage barges existing along the world's major shipping routes (FIG. 3) will maintain a roughly stationary position and serve as an at sea refuel option for passing cargo ships. Additionally, they can deposit fuels/commodity chemicals into the cargo ships that can then be used on land.

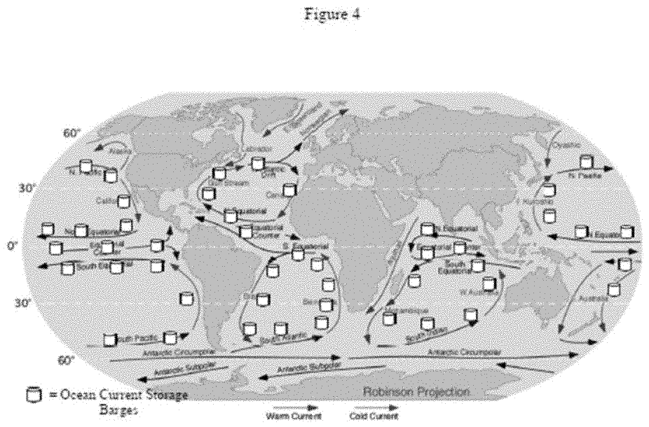

Storage barges positioned on major ocean currents (FIG. 4) could slowly maneuver around the world's oceans and adjacent to most continents. This can provide renewable energy access to the 40% of humans that live within 60 miles of the ocean.

The invention is optimal for global scale solar power for the following reasons:
Optimized production: Ocean based supply barges will follow a North/South annual migration pattern, This will include migration North and South of the equator in Summer and Winter, respectively. This will allow for an annual average day length longer than any stationary latitude. Consequently, supply barges will have incident solar radiant energy that is better or comparable with the best known in the world.
Cost, convenience, and timeline: All other things equal, the disclosed supply barges will provide the lowest Solar LCOE energy in the World. Carbon can be captured from seawater and/or air to produce many of the Carbon-based fuels/chemicals our World is currently dependent on from fossil fuels. For example, Natural gas utilities can maintain operation in a carbon neutral process. This will minimize required land-based infrastructure changes and speed humanities transition away from fossil fuel based products/fuels.
Energy reserve: With the proper scale, storage barges can provide a decentralized international energy storage means with 100+ years of supply necessary for human survival. A reservoir of this size would rival known stores of Fossil Fuels and Nuclear Fission. This is necessary for renewable energy to be viewed as a default choice vice an intermittent source. Furthermore, this could be a necessary factor for humanities survival in the event of catastrophic event, such as the one that is theorized to have led to extinction of the dinosaurs. With current battery design and known stores of necessary metals (namely Lithium and Cobalt), energy storage on this order of magnitude cannot be achieved.

The invention is optimal for powering transoceanic shipping for the following reasons:
Fuel tank optimization: With an at sea refueling option, fuel tank volume can be minimized to allow more room for cargo. Fuel tank pressure can be minimized to allow a less robust/expensive design. Fuel tank refrigeration, specifically for Liquid Hydrogen, can be eliminated for energy savings (with Hydrogen stored as a gas instead).
Land Based Electrical grid stress: Any solar/wind power produced on land should be used to directly power the local grid.
Lack of Raw materials in High Solar insolation environments: The world's highest land-based solar insulation environments exist in deserts. (Examples: Sahara Desert, Australia, Middle East, Southwestern United States). They are naturally devoid of the required ingredient (water) to produce chemical fuels. This then requires transportation of vast quantities of water or electricity hundreds of miles.

This invention could be scaled to be a system of millions of barges collecting and distributing solar (as well as wind/wave) energy throughout the World's oceans. This solar energy would propel the entire global economy's large cargo shipping. This solar energy could also be harnessed as an eco-friendly option in the chemical production of most of the fuels and commodity chemicals necessary for human life. The system may be used to gather large amounts of weather and other oceanographic data throughout the world's oceans.

1. A method for increasing annual incident solar energy and thus production rate of renewable fuels/chemicals derived from air and seawater via an ocean based annual migration pattern by use of slow speed/low drag force travel of ˜1 nautical mile per hour in the North/South directions.

2. An Ocean based International Decentralized renewable energy grid and commodity chemical supply process with the potential to store energy/chemical reserves of 100+ years and provide these at low cost to any coastal region in the World

3. A system of Supply and Storage barges that provide chemical fuels for at-sea refueling of large-scale transoceanic shipping along the World's major shipping lanes
